(19) United States
(12) Patent Application Publication
(10) Pub. No.: US 2024/0377648 A1
(43) Pub. Date: Nov. 14, 2024

(54) NOSE PAD EYE/GAZE TRACKING MODULE APPLICABLE TO SMART GLASSES OR HEAD WEARABLE DEVICE

(71) Applicant: VIEWPOINTSYSTEM GMBH, Wien (AT)

(72) Inventors: Johannes VOIGT, Feldkirch (AT); Primoz FLANDER, Wien (AT); Frank LINSENMAIER, Weinstadt (DE); Nils BERGER, Schaan (LI)

(73) Assignee: VIEWPOINTSYSTEM GMBH, Wien (AT)

(21) Appl. No.: 18/690,842

(22) PCT Filed: Sep. 9, 2022
(86) PCT No.: PCT/EP2022/075073

§ 371 Date: Mar. 11, 2024

(30) Foreign Application Priority Data
Sep. 9, 2021 (WO) PCT/EP2021/074787

(51) Int. Cl. G02B 27/01; G02C 5/12

(52) U.S. Cl. CPC G02B 27/0179; G02B 27/0172; G02C 5/12; G02B 2027/0187

(57) ABSTRACT

The present invention relates to a nose pad eye/gaze tracking module applicable to known augmented/virtual reality glasses, to visual remote guide devices in general, constituting the nose pads part of said devices, without using any kind of connector. The invention further relates to a method for fastening the nose pad eye/gaze tracking module to said kind of device.

### CROSS-REFERENCE TO RELATED APPLICATIONS

The present application is a national phase application of PCT Application No. PCT/EP2022/075073, filed Sep. 9, 2022, entitled “NOSE PAD EYE/GAZE TRACKING MODULE APPLICABLE TO SMART GLASSES OR HEAD WEARABLE DEVICE”, which claims the benefit of PCT/EP2021/074787, filed Sep. 9, 2021, entitled “NOSE PAD EYE/GAZE TRACKING MODULE APPLICABLE TO SMART GLASSES”, each of which is incorporated by reference in its entirety.

### BACKGROUND OF THE INVENTION

### 1. Field of the Invention

The present invention discloses a nose pad eye/gaze tracking module applicable to smartglasses/head wearable devices implementing extended reality technology (augmented/virtual/mixed reality AR, VR, MR) in general. The invention further deals with a method for fastening the module to said smart eyeglasses/head wearable device (also referred to as a head wearable device herein) and with an eye/gaze tracking device (also referred to as a gaze tracking device herein) comprising smart eyeglasses/head wearable device provided with the nose pad eye/gaze tracking module.

### 2. Description of the Related Art

Eye-tracking devices and in particular spectacles usually comprise a camera, which is oriented onto the eye of the spectacles wearer; such a camera is able to detect the pupil of the user in order to ascertain the coordinates of the pupil in the space. Gaze tracking devices further comprise a front camera able to capture the scenario in front of the user, in this case, the device is able to determine the viewing direction of the user's eyes which can be displayed on a correspondent display computer device to a second user remotely connected via internet live streaming.

US2016/0206196 discloses gaze-tracking spectacles comprising two eye cameras arranged in the nose frame of the glasses and a field of view camera in the middle of the glasses, showing the front scenery of the user.

The field of view camera is provided to record a field of view, video including individual and successive field of view images. The recordings of the two eye acquisition cameras and the at least one field of view camera can thus be entered in correlation in the field of view video of the respective gaze point.

Unfortunately, this prior art document discloses eye tracking glasses having a frame similar to normal pair of glasses.

Furthermore are known augmented/virtual/mixed reality glasses, have a very minimal spectacles frame, including a horizontal upper part provided with an element constituting the nose frame, in order to have the device placed stably and supported by the nose of the user.

WO2021/164867 discloses an eye tracking module applicable to smart glasses and goggles and the head wearable device mounting that module. This document is focused on connecting the module to head-wearable devices from the wearer's side (see FIGS. 2A, 2B, 5A, 5B, 5C), in particular using the front camera assembly. This type of connection has implicit drawbacks related to the reduced space left between the nose of the user and the head-mounted frame, and obliges the head-mounted device manufacturer to space away the device from the user's face, ending with a not comfortable device that may slip often on the nose of the user, due to its weight and dimension even if it is strapped on the user's head. The document also describes another type of connection, that is the module being connected to head-wearable devices from the side facing away from the wearer (see FIGS. 4A, 4B). However also this type of connection has the same problem already mentioned before and, in addition, possible further interferences with the eye sensor may occur, due to the increased distance of the module from the user's eyes.

The document furthermore only generally mentions in paragraph 62 that “alternatively, the electric connector may be arranged on a top surface of the module”, without describing in detail any specific embodiment of this type of connection. In particular, it is only mentioned a possible position of electronic connector but not any mechanical interface able to connect stably in place the module on the head-mounted device, in order to avoid accidental or unwanted disconnection, or even worse any signal losses due to inappropriate connection, when the module is connected to the head-mounted device.

### SUMMARY OF THE INVENTION

One objective of the present invention, according to a first of its aspects, is obtaining an eye/gaze tracking module, being a finished product, ready to be used once mechanically connected to the smart glasses, like augmented or virtual, or mixed reality glasses, able to minimize the impact space-wise of the module once connected to the head-worn device.

A second objective of the present invention is to obtain an eye/gaze tracking module with no connector, thus further minimizing the dimension of the module.

A third objective of the present invention is giving the possibility to make augmented or virtual or mixed reality glasses able to be customized and to fit immediately to different somatic features typical of different ethnic groups for instance Asian people, and European people, avoiding the necessity to create different and specific smart glasses models. A fourth objective of the present invention is giving the possibility to the user to easily fasten and unfasten an eye/gaze tracking module to/from his/her own smart eyeglasses/head wearable device.

A fifth objective of the present invention is to provide an eye/gaze tracking module easily adaptable to different smart glasses frames, easy to be cleaned, and at the same time firmly attachable to said smart glasses.

A further objective of the present invention is to provide an eye/gaze tracking module able to not interfere with the user's nose, being not in contact with it and/or with the user's field of view, once fastened to the smart glasses.

A further objective of the present invention is to provide an eye/gaze tracking module very light weighted, compact, and characterized by reduced dimensions, comfortable for the user.

Another objective of the present invention is to provide an eye/gaze tracking device reliable, and easy to be used by the user, with a reduced cost with respect to known eye tracking devices.

Another objective of the present invention is to provide a fastening method easy to be implemented by users.

Hereinafter are summarized some technical aspects of the present inventions which enable some of the most important purposes to be achieved.

According to a first aspect this invention relates to an eye/gaze tracking module configured to be easily fastened/unfastened to/from a pair of smart spectacles or working eye glasses not having any nose pads, thus creating an eye/gaze tracking device, said module comprising a first part, having a U-shaped portion, housing at least one left eye sensor and one right eye sensor to detect pupil positions of the user in a plurality of images, said module further comprising a second part, housing a mechanical interface configured to connect the module to the smart/working spectacles, said module further comprising electronic components namely at least a data processing unit, a memory, a data interface, enclosed in the first part frame or in the second part frame, said electroniccomponent configured to connect the module to a computer device remotely connected or to other devices in general, and to send to said computer device eye movement information of the user wearing the spectacles to which is fastened the module, wherein the mechanical interface, arranged on the second part frame, comprises a specific upward section shape connectable to a correspondent downward section shape of the central portion or of a further extension at the central portion of the smart eye glasses/head wearable device, thus making the module configured to be bottom-up connectable to the smart eye glasses/head wearable device.

In this case the bottom-up connection between the module and the smart eye glasses/head wearable device at the central portion, implies a very reduced space occupied by the module when in use, which is compact and very small.

According to a second aspect this invention relates to a module further comprising a PCB configured to further be the mechanical interface connectable to the smart eye glasses/head wearable device.

In this case the further mechanical connection provided by the PCB prevent the need to have a real or physical connector on the module, this solution contributing to minimize the overall dimension of the module.

According to further aspects, this invention relates to further module, product and method feature claimed in the dependent claims of the present specification.

### BRIEF DESCRIPTION OF THE DRAWINGS

The structural and functional features of the present invention and its advantages with respect to the known prior art, will become even clearer from the underlying claims, and in particular from an examination of the following description, made with reference to the attached figures which show a preferred but not limited schematic embodiment of the invented method, system, device, in which:

FIG. 1 illustrates a three-dimensional view of a preferred embodiment of the nose pad eye/gaze tracking module according to the present invention;

FIGS. 2 and 3 illustrate respectively a three-dimensional view of the smart eyeglasses/head wearable device 8 which is connected and not connected to the first embodiment of the nose pad eye/gaze tracking module 1.

FIGS. 4 to 14 illustrate three-dimensional views of preferred embodiments of the connection of the nose pad eye/gaze tracking module according to the present invention and the correspondent counterparts of the smart eyeglasses/head wearable device.

### DETAILED DESCRIPTION

In general, this disclosure describes a nose pad eye/gaze tracking module 1, a method for fastening/unfastening the module to/from different kinds of smart eyeglasses/head wearable device 8, and an eye/gaze tracking device comprising smart eyeglasses/head wearable device 8 provided with the nose pad eye tracking module 1.

The specifications “right” or “left” or “high” or “low” or “front” or “back” relate to the intended manner of wearing eyeglasses and the eye tracking module by a human being.

Regarding smart eyeglasses/head wearable device 8 in general, it shall be highlighted that they have at least an upper part of their frame having the purpose to hold the temples and if necessary retaining the lenses, which could be sun lenses or specific filtering/protective lenses or lenses in general. Furthermore, they may have at least a portion, so-called nose bridge, acting as a spacer between the two lenses, able to create space for the user's nose.

The nose bridge is a portion necessary in all eyeglasses, but in some cases, this portion is not clearly detectable, for example in head wearable device or head-mounted headset. In some cases, like smart glasses provided with extended technology (see FIG. 2), the central portion 88 of the upper frame of the smart glasses, may be a suitable frame portion or may have a specific mechanical interface where the eye tracking module of the present invention may be fastened.

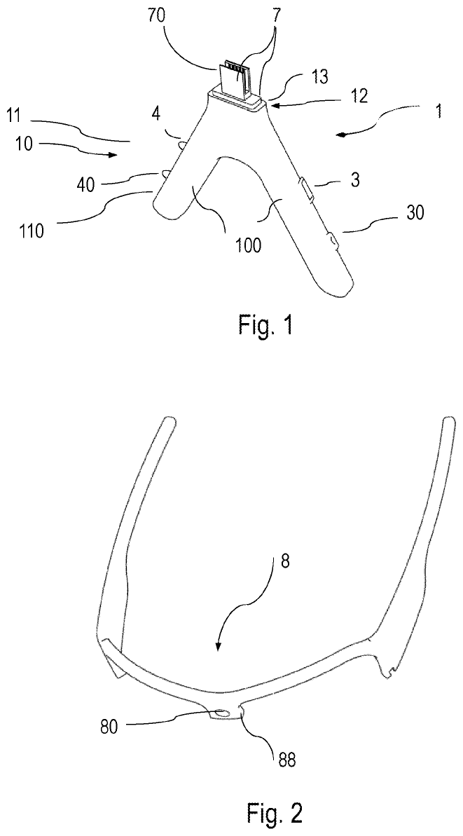

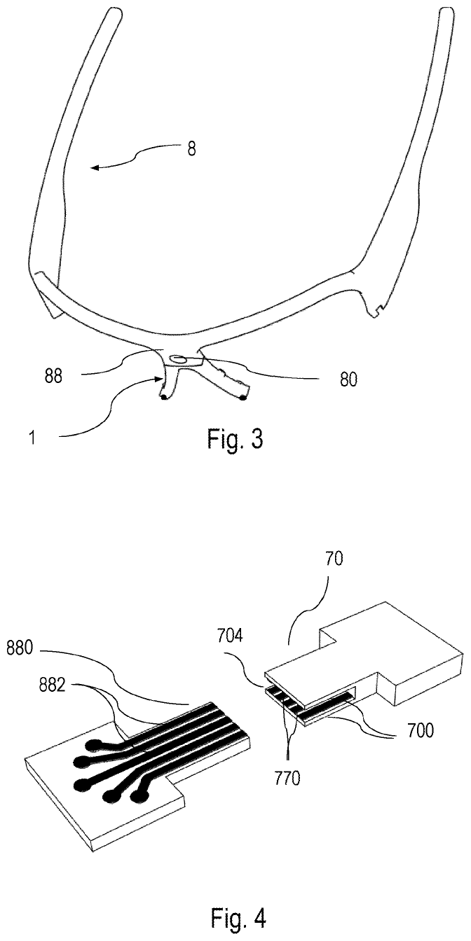

The nose pad eye tracking module 1, according to the present invention, comprises a first part 10, comprising a first part frame 11, having, in turn, a U-shaped portion 110. In said U-shaped portion 110 are preferably located a right eye acquisition sensor 4 and a left eye acquisition sensor 3, which have the purpose of taking images of each user's eye, in order for the position of the pupil in the space to be detected (see FIG. 1).

The left and right eye sensors 3, and 4 may be preferably eye cameras but may be different kinds of technologies like lasers able to scan the user's eyes to detect the position of pupils or microelectromechanical systems like for instance MEMS-based scanning elements.

The module furthermore comprises a second part 12, having a second part frame 13, housing—in a preferred embodiment—a mechanical interface 7 (see FIG. 1). Said mechanical interface 7 is configured to easily and stably fasten itself to a correspondent mechanical interface arranged in the central portion.

Said mechanical interface 7 in all the embodiments described in the present specification is provided also with an electrical/electronic interface, in order to electrically/electronically connect the nose pad eye/gaze tracking module 1 with the smart eyeglasses/head wearable device 8.

In a preferred embodiment the mechanical interface 7 on top of the second part frame 13 exploits the action of the laminated insulating material forming part of a PCB (see FIG. 1) besides the conduction material of the PCB, providing the electrical and electronic interfaces, which are able to establish the signal connection between the nose pad eye/gaze tracking module 1 and the smart eyeglasses/head wearable device 8. Said PCB is included in the nose pad eye/gaze tracking module 1 and supports and serves the mentioned electronic components.

It's important to highlight that the bottom-up connection between the module 1 and the smart eyeglasses/head wearable device 8 at the central portion 88, implies a very reduced space occupied by the module 1, because the available space is very small between the smart eyeglasses/head wearable device 8 and head of the human being, when between the smart eyeglasses/head wearable device 8 and the nose pad eye/gaze tracking module 1 are connected together and in use.

The U-shaped portion 110 comprises two arms 100, and is particularly designed for being used as nose pads, thus being configured to make the smart eyeglasses/head wearable device 8 easily customizable on different nose shapes when the module is fastened to said smart eyeglasses/head wearable device. The nose pad eye/gaze tracking module 1 of the present invention is used, replacing, the nose pads of the smart eyeglasses/head wearable device 8, without interfering with the user's nose.

The U-shaped part 110 may be made of soft materials, and in particular, the arms 100 may be made with flexible material, in order to further better adapt the arm 100 shapes to the nose of the user and to cooperate fastening the module on the smart eyeglasses/head wearable device 8 as described hereinafter.

As mentioned before, in a preferred solution, the right eye acquisition sensor 4 is arranged in the right arm 100, and the left eye acquisition sensor 3 is arranged in the left arm 100 of the U-shaped portion 110. When the two eye acquisition sensors 3, and 4 are designed as digital cameras they may have an objective lens. The two eye acquisition cameras 3, and 4 are each configured to prepare an eye video including individual eye images or individual images of the eyes of the human wearing the eye tracking module. Said eye acquisition cameras 3, 4 must be directed towards the position of the eyeball of the wearer.

In a possible configuration (see FIG. 2) the recording of the two eye acquisition sensors 3, 4 can enter in correlation with the recording of a field of view camera 80 already present on the central portion 88 of the smart eyeglasses/head wearable device 8, giving the respective gaze point of the user in the field of view video (when the module is fastened to the smart eyeglasses/head wearable device 8).

At least one field of view camera (not present in the drawings) is arranged on and/or in the module 1, in each embodiment disclosed in the present specification. The field of view camera records a field of view video, including individual and successive field of view images. In that case, the recordings of the two eye acquisition sensors 3, 4 and the at least one field of view camera can thus be entered in correlation in the field of view video of the respective gaze point of the user (when the module is fastened to the smart eyeglasses/head wearable device.

More than one field of view cameras may also be arranged in and/or the nose pad eye tracking module 1, in each embodiment disclosed in the present specification.

Furthermore, the module has electronic components like a data processing unit (like a microprocessor), a connected storage medium, and a data interface, the data processing unit being connected to the right eye acquisition sensor 4 and the left eye acquisition sensor 3. The module furthermore may have an energy accumulator for the energy supply of the eye sensors 3, 4, and also the data processing unit, memory, and the data interface. The module furthermore may have an external power supply via cable, or an internal battery and a correspondent power interface, not shown in the schematic drawings.

In each embodiment disclosed in the present specification the electroniccomponents, including a data processing unit (like a microprocessor) and a connected storage medium, and at least a data processing unit, a memory, a data interface, a power unit/interface, may be arranged in the first part 10, or in the second part 12 or some of them in the first part 10 and other ones in the second part 12.

Furthermore because of these electronic components are enclosed inside the relevant module frames and the module frame shapes are sealed and have no sharp edges, the module disclosed in the present invention is also easy to be cleaned. Furthermore, the frame of each part where these electronic parts are arranged, encloses them, conferring them protection against accidental hits, dust, or in general external agents which might compromise said part operations (the drawings provided are schematic and do not have limiting purposes).

In each embodiment disclosed in the present specification a data processing unit may be preferably designed as a combination of a microcontroller or processor together with memory. The data processing unit is connected in a signal-conduction manner to a data interface. The data interface and the data processing unit may be formed jointly in hardware, for example, by an ASIC or an FPGA. The interface is preferably designed as a wireless interface, for example, according to the Bluetooth standard or IEEE 802.x, or as a wired interface. Additional sensors might be inserted in the eye tracking module and connected to the data processing unit.

In each embodiment disclosed in the present specification the data processing unit, the memory and the data interface may be connected at least indirectly to an energy accumulator by circuitry, and are connected in a signal-conduction manner to the field of view camera (when present), the right eye acquisition sensor 4, and the left eye acquisition sensor 3.

It shall be highlighted that in each embodiment disclosed in the present specification, the entire recording, initial analysis, and storage of the recorded videos may thus be performed in or by the eye tracking module itself or by a computer device connected (wireless or via cable) to the module.

Regarding the U-shaped portion 110 where are arranged at least one left eye sensor 3 and one right eye sensor 4, in each embodiment disclosed in the present specification also a left Infrared LED illuminator 30 and a right Infrared LED illuminator 40 may be arranged in said U-shaped portion 110. Said illuminators 30, 40 help to better detect pupil positions of the wearer's eyes, when in use.

In order to connect the module the nose pad eye/gaze tracking module 1 to the smart eyeglasses/head wearable device 8, is already mentioned above that the mechanical interface 7 on top of the second part frame 13, comprises the action of the laminated insulating structure forming part of a PCB (see FIG. 1) included in the nose pad eye/gaze tracking module 1 and serving and supporting the mentioned electronic components.

In a preferred embodiment an ending portion 70 of the PCB included in the nose pad eye/gaze tracking module 1 is shaped like a female connection (see FIG. 4), said ending portion 70, which may be designed coming out from the second part frame 13 of the nose pad eye/gaze tracking module 1 or in any case being accessible from the last one.

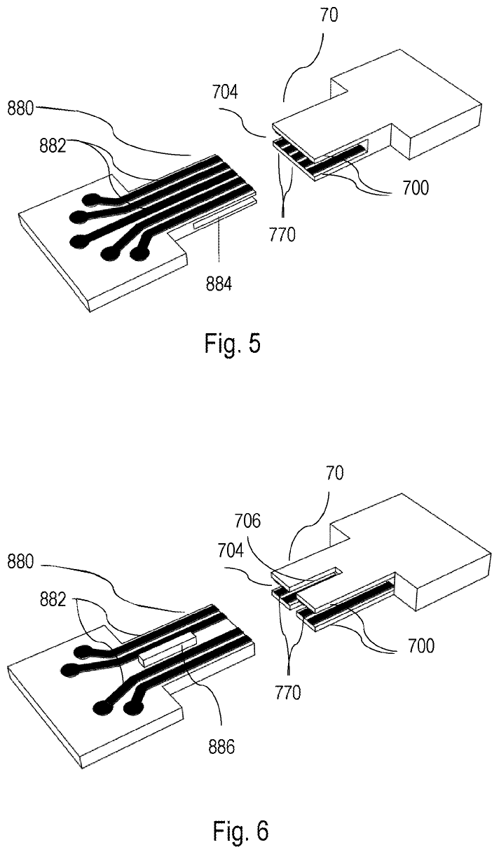

The ending portion 70 may have a rectangular cross-section, comprising two parallel elements 700, spaced apart from one another. The space between the two parallel elements forms a suitable seat 704 for a correspondent ending portion 880 (in this case a male part) of a PCB included in the smart eyeglasses/head wearable device 8. The seat 704 comprises a suitable number of conduction traces 770, corresponding to the number of conduction traces 882 of the ending portion 880. When the ending portion 880 of the smart eyeglasses/head wearable device 8 is connected stably with the ending portion 70 of the nose pad eye/gaze tracking module 1, then both devices have established electrical and electronic connections, being able to communicate with each other. The ending portion 880 may further be shaped with two parallel elements spaced apart from one another and defining a space 884, allowing the two parallel elements to get close to each other when both are inserted in the seat 704 of the ending portion 70. In this case, the two parallel elements 700 are less forced to bend outwardly when the two devices are connected because that movement is compensated by the opposite movement of the two parallel elements of the ending portion 880 (see FIG. 5).

In all the embodiments described in the present invention, the ending portion 70 of the PCB of the nose pad eye/gaze tracking module 1 is designed to firmly and stably hold in place the correspondent ending portion 80, maintaining the continuity of the signal between the two devices and preventing any loss of communication between them. It shall be highlighted furthermore that, being established a bottom-up connection between the two devices and acting the nose pad eye/gaze tracking module 1 as the nose pad of the smart eyeglasses/head wearable device 8 when both are connected together. The connection between the two devices is forced to be maintained stable due to the weight of the smart eyeglasses/head wearable device 8 itself. This particular aspect is peculiar to all the embodiments of the present invention.

In a further preferred embodiment the ending portion 70 of the PCB included in the nose pad eye/gaze tracking module 1 is shaped in the same way as the already mentioned embodiment like a female connection (see FIG. 6), but both two parallel elements 700 comprises a longitudinal aperture 706, allowing the separation between two couples of conduction traces 770 and further allowing the insertion of a guide 886 arranged in a correspondent and congruent position on the ending portion 880 of the smart eyeglasses/head wearable device 8. The longitudinal aperture 706 cooperating with guide 886 allows a better alignment during the connection between the two devices. The guide element may be provided in all the embodiments described in the present specification, in order to offer a proper alignment during the connection of the two devices.

A further embodiment not described in the figures may have a plurality of longitudinal apertures aiming to physically separate each conductive trace between one another either on the ending portion 70 and on the ending portion 80, in order to allow a certain flexibility in tolerances during the connection between the two devices.

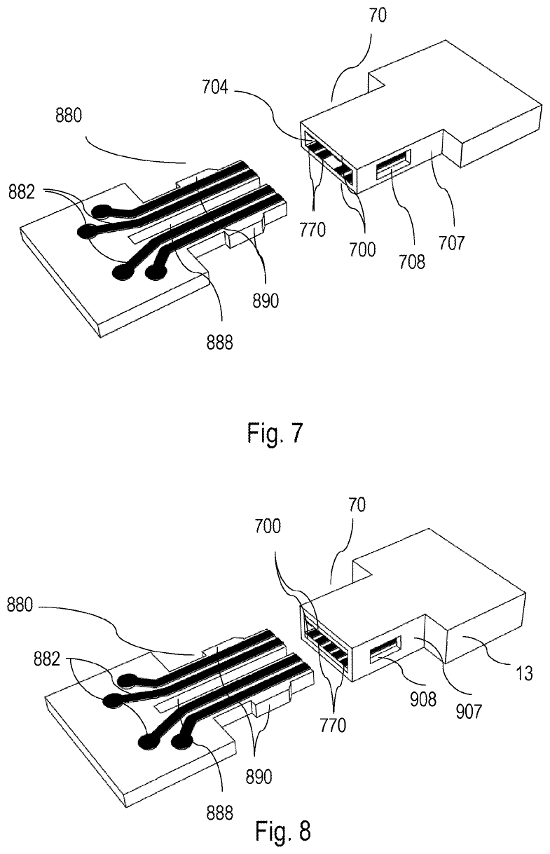

In a further preferred embodiment (see FIG. 7) the ending portion 70 is configured in such a way to create a seat 704 bounded on the upper and lower sides by the two parallel elements 700, and laterally by two other sides 707, each comprising, in turn, a slot 708 suitable to engage a correspondent retaining lip 890 provided on a compatible and congruent position on the opposite sides of the ending portion 880 of the smart eyeglasses/head wearable device 8. The retaining lips 890 are able to engage connecting ledges of the slots 708, because of the presence of a longitudinal aperture 888, allowing the retaining lips 890 to get close together, once the two devices are connected together, thus acting as a snap-fit profile. In this case, the connection is more stable and robust and due to the snap-fit profile, it makes the fastening and unfastening steps very easy. The slot+retaining lips elements may be provided in all the embodiments described in the present specification, in order to achieve a robust connection between the two devices.

This embodiment may also be configured with the second part frame 13 acting as the counterpart of the snap-fit profile, instead of the PCB (see FIG. 8). In this case the second part frame 13 surrounds the ending portion 70, bounding the two parallel elements 700 and proving sidewalls 907, comprising in turn suitable slot 908 able to engage the correspondent retaining lip 890. With this solution it's prevented any mechanical stress on the PCB.

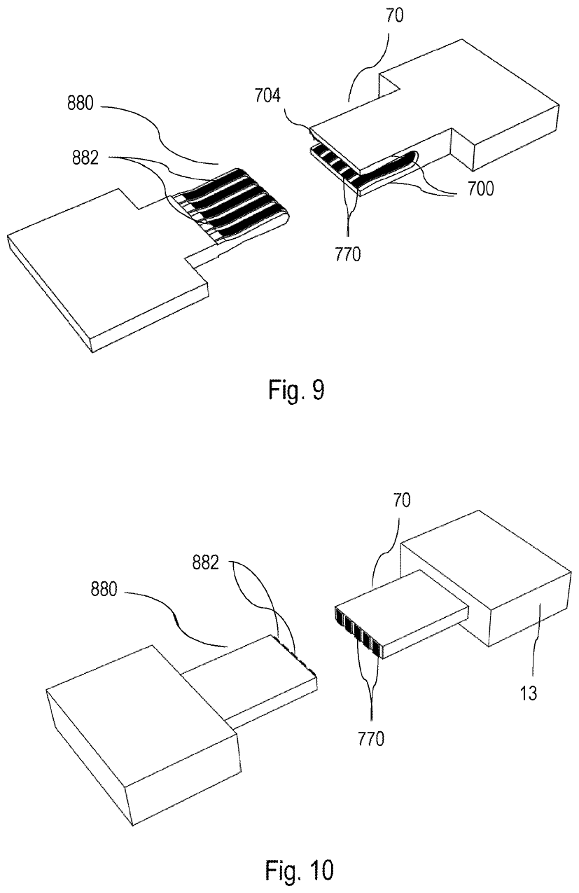

The embodiment of FIG. 4 is further improved, offering a snap fit profile along the longitudinal cross-section of the seat 704 (see FIG. 9) and of the correspondent ending portion 880. The seat 704 has a maximum longitudinal cross-section width corresponding to the minimum longitudinal cross-section width of the ending portion 880 and another way round the seat 704 has a minimum longitudinal cross-section width in correspondence of the maximum longitudinal cross-section width of the ending portion 880. Both the conduction traces 770 and 882 follow the corresponding shape of respectively seat 704 and ending portion 880. The two parallel elements 700, being able to distance themselves from each other, completing the snap-fit mechanism. The same effect might be achieved using metallic springs acting as a retaining mechanism using metallic springs acting as a retaining mechanism, to hold in place the ending portion 880, when it is connected into the seat 704 of the ending portion 70. The longitudinal section profile feature may be implemented in all the embodiments described in the present specification, in order to reduce the number of components needed for the connection of the two devices.

In a further preferred embodiment (see FIG. 10+11), the conduction traces 770 are arranged on the very top side of the ending portion 70 coming out from the second part frame 13, being able to match correspondent conduction traces 882 on the very top side of the ending portion 880 of the PCB included in the smart eyeglasses/head wearable device 8. Designing the conduction traces 770 even on the very top side of the ending portion 70 is a feature that may be implemented in all the embodiments described in the present specification; this technical aspect increases the conduction surfaces, further preventing the risk of interrupting the electrical/electronic continuity between the two devices when they are connected together.

In this case, the mechanical retaining force needed when the two devices are connected together is provided by a magnet 5, designed to bounder the ending portion 70, being able to attract a correspondent magnet 890 arranged on the ending portion 80, in order to hold in position the nose pad eye/gaze tracking module 1 on the smart eyeglasses/head wearable device 8 when in use. The use of a magnet 5 surrounding the ending portion 70 to improve the stability of the connection of the two devices, may be arranged in all the embodiments described in the present specification.

The last embodiment described may be further improved, arranging the second part frame 13 further totally bounding the magnet 5 and further creating a boundary seat 705 around the very ending portion 70, said boundary seat 705 configured to match a congruent protrusion 885 of the ending portion 80, thus offering a guide for an easy connection of the two devices together (see FIG. 10+12). The seat 705 may house a seal (not visible in the figures), particularly designed to adhere perfectly to correspondent surfaces when the two devices are connected together, in order to further make the connection waterproof.

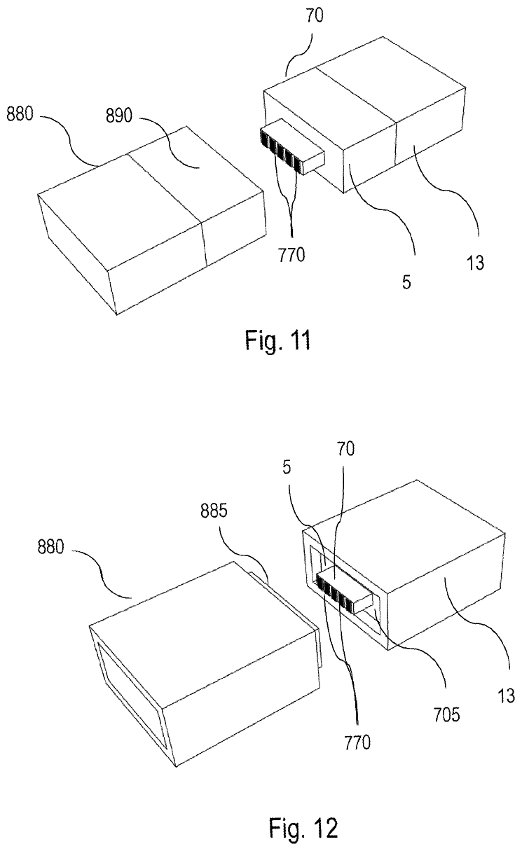

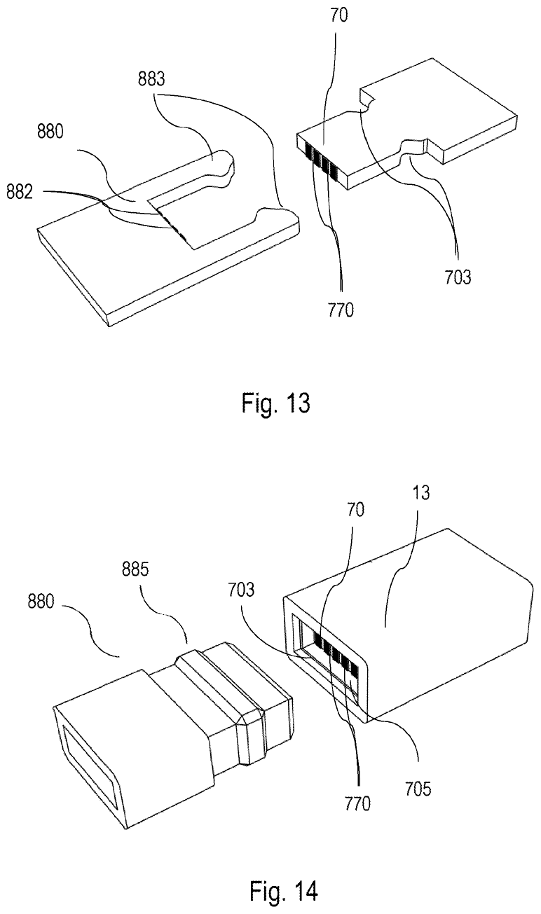

An improvement of the embodiment shown in FIGS. 10, 11, and 12 is shown in FIG. 13. The conduction traces 770 are arranged on the very top side of the ending portion 70 coming out from the second part frame 13 and the ending portion 70 further comprises lateral engaging notches 703, acting as the counterpart of a snap-fit mechanism present on the ending portion 80. The last one in fact is equipped with conduction traces 882 arranged centrally, on the very top side of the ending portion 880, and with two lateral protruding arms having retaining lips 883 designed to engage firmly the lateral engaging notches 703. In this case, a stable connection is achieved only using a particular design of the ending portion 70 of the PCB of the nose pad eye/gaze tracking module 1. Designing notches plus retaining lips laterally on the ending portion 70 of the PCB of the module 1, may be provided in all the embodiments described in the present specification, in order to provide a snap-fit profile, may be implemented in all the embodiments disclosed in the present specification.

Another improvement of the embodiment shown in FIGS. 10, 11, 12 is shown in FIG. 14. Here the ending portion 70 has still conduction traces 770 arranged on the very top side of itself, but then it is bounded by second part frame 13 which is configured to create a specifically designed seat 705, in turn comprising a bounding engaging notch 703. The ending portion 880 is specifically designed with a bounding retaining lip 885, congruent with the bounding engaging notch 703, and matching it when the two devices are connected. In this case the second part frame 13 provides the mechanical interface on top of the nose pad eye/gaze tracking module 1. Having in place this particular mechanical interface on the top surface of the module 1, namely designing a snap fit profile on the second part frame 13 of the module 1, it's a technical feature that may be implemented in every embodiment disclosed in the present specification. The seat 705 may also in this embodiment house a seal (not visible in the figures), particularly designed to adhere perfectly to correspondent surfaces when the two devices are connected together, in order to further make the connection waterproof.

It must be highlighted that in all the embodiments described so far, the ending portion 70 of the PCB of the nose pad eye/gaze tracking module 1 is designed as the female part of the connection between the two devices and the ending portion 880 of the PCB of the smart eyeglasses/head wearable device 8 as the male part, but the two ending parts 70, 880 may be exchanged in the opposite way in order to better meet specific technical requirements of the smart eyeglasses/head wearable device 8 manufacturers. Therefore the ending portion 70 may be designed as a male part of the connection as already described in each embodiment and the ending portion 880 as the correspondent female part.

In the embodiment shown in FIG. 1 is disclosed a specific upward section shape of that second part frame 13 (rectangular in FIG. 1) connectable to a correspondent downward section shape (not visible in the drawings) of the central portion 88 of the smart eyeglasses/head wearable device 8, and/or in addition the PCB ending part 70 connection to a correspondent PCB ending part of the smart eyeglasses/head wearable device 8 (not visible in the drawings) on the central portion 88 of the smart eyeglasses/head wearable device 8. It's important to point out that the mentioned downward section shape may be also designed as an element extending down from the central portion 88 of the smart eyeglasses/head wearable device 8. Said specific upward section shape of that second part frame 13 has the function of guiding during the connection and further fastening the module 1 to the smart eyeglasses/head wearable device 8.

Finally, it may be provided an embodiment where the ending portion 70 has physically separated support of conductive traces, with they arranged on a lateral side of their respective support. In this case, expecting the same configuration on the correspondent counterpart ending portion is obtained an embodiment able to provide a rotating mounting connection between the two devices.

As already described, when the module comprises a field of view camera, it is able to detect a plurality of images, such as video images, of the field of view of the wearer the nose pad eye tracking module, once fastened when in use. Said field of view camera may be arranged in a part of the frame of the module 1 facing outwardly the smart eyeglasses/head wearable device 8 when in use, or may be arranged in a portion of the frame, which may be configured to be higher than the upper portion of the frame of the smart eyeglasses/head wearable device 8, when the eye tracking module is fastened to the smart eyeglasses/head wearable device 8.

It shall be highlighted that in each embodiment disclosed in the present invention the two arms 100 are designed in such a way to be used as nose pads configured to make the smart eyeglasses/head wearable device 8 customizable on different nose shapes when the module is fastened to said smart eyeglasses/head wearable device 8.

The nose pad eye/gaze tracking module 1 disclosed in the present invention, due to its dimension reduced size and its described configuration, results in a very light weighted module, not affecting the user's comfort, when he is wearing his/her smart eyeglasses/head wearable device 8 to which is fastened the module.

The present invention further relates to a method for fastening the nose pad eye tracking module 1 to a smart eyeglasses/head wearable device 8, wherein the eyeglasses 8 and module 1 have structures already described in this specification, according to all the embodiments described. The method comprises the following steps:
bottom-up connecting the nosepad eye/gaze tracking module 1 to the smart eyeglasses/head wearable device 8 at the central portion 88 of the smart eyeglasses/head wearable device 8.

The present invention further relates to an eye/gaze tracking device comprising a pair of smart eyeglasses/head wearable device 8 and the nose pad eye tracking module 1, wherein the smart eyeglasses/head wearable device 8 and the nose pad eye/gaze tracking module 1 have structures already described in this specification, according to all the embodiments described.

1-15. (canceled)

16. A nose pad eye tracking module configured to be at least one of fastened to and unfastened from a head wearable device, thus creating a gaze tracking device, the eye tracking module comprising:
a first part having a first part frame having a U-shaped portion including two arms and being adaptable and compatible with a nose of a user when in use, said first part frame housing at least one left eye sensor and one right eye sensor, said eye sensors being arranged on the arms to detect a plurality of pupil position images of the user when in use;
a second part having a second part frame and including a mechanical interface configured to connect the module to the head wearable device;
electronic components including at least a data processing unit, a memory, and a data interface, said electronic components being configured to connect the module to a computer device and to send to said computer device eye movement information of the user wearing the smart glasses to which is fastened the nose pad eye tracking module when in use, wherein the module is a finished product being ready to be used once mechanically and electrically fastened to the head wearable device;
wherein the first part comprises two arms designed as nose pads configured to be customizable on different nose shapes when the module is fastened to the head wearable device;
wherein the mechanical interface is arranged on a top of the second part frame and comprises electrical and electronic interfaces connectable to corresponding downward mechanical, electrical, and electronic interfaces arrangeable on one of:
a central portion of the head wearable device; and
a further extension of the central portion of the head wearable device; and
wherein the module is configured to be bottom-up connectable to the head wearable device.

17. The module according to claim 16, wherein the second part frame comprises an upward section shape connectable to a corresponding downward section shape of one of the central portion and the further extension of the central portion of the head wearable device.

18. The module according to claim 16, wherein the mechanical interface comprises an ending portion of a PCB.

19. The module according to claim 18, wherein the ending portion comprises two parallel elements made by insulating material forming part of the PCB and being spaced apart from one another thus forming a seat, the seat being adapted to house a corresponding ending portion of a further PCB included in the head wearable device, said two parallel elements supporting a number of conduction traces facing the seat.

20. The module according to claim 19, wherein the two parallel elements comprise a longitudinal aperture providing separation of at least two couples of conduction traces and further providing insertion of a guide arranged in a corresponding and congruent position on the corresponding ending portion of the head wearable device.

21. The module according to claim 19, wherein a longitudinal cross-section of the seat provides a snap-fit connection between the ending portion and the corresponding ending portion, said seat having a first maximum longitudinal cross-section width corresponding to a first minimum longitudinal cross-section of the ending portion and having a second minimum longitudinal cross-section width corresponding to a second maximum longitudinal cross-section width of the ending portion, when the ending portion and the corresponding ending portion are connected together.

22. The module according to claim 19, wherein the seat is bounded laterally by two other sides, each comprising a slot suitable to engage a correspondent retaining lip arrangeable on a compatible and congruent position on the opposite sides of the ending portion of the head wearable device.

23. The module according to claim 19, wherein the seat is bounded laterally by two other sides, each comprising a slot suitable to engage a corresponding retaining lip provided on a compatible and congruent position on opposite sides of the corresponding ending portion of the head wearable device, said two other sides being part of the second part frame surrounding the ending portion and bounding the two parallel elements.

24. The module according to claim 19, wherein the conduction traces are arranged on a top side of the ending portion and match correspondent conduction traces on a further top side of the ending portion of the PCB included in the head wearable device.

25. The module according to claim 24, further comprising a magnet bounding the ending portion, the magnet configured to attract a corresponding magnet arrangeable on the ending portion when in use.

26. The module according to claim 24, wherein the ending portion comprises lateral engaging notches, the ending portion being configured to engage suitable retaining lips of two lateral protruding arms of the ending portion when in use.

27. The module according to claim 16, wherein the mechanical interface comprises one of:
a guide;
at least two retaining lips;
a longitudinal aperture dividing two conduction traces;
a plurality of longitudinal apertures dividing each conduction trace from one another;
two lateral protruding arms having retaining lips configured to firmly engage corresponding lateral engaging notches designed on a corresponding counterpart ending portion; and
a protrusion on the second part frame configured to match a corresponding boundary seat on the corresponding counterpart ending portion.

28. The module according to claim 16, wherein the module comprises at least one field of view camera.

29. A method for fastening a nose pad gaze tracking module to a head wearable device, wherein:
the nose pad gaze tracking module is configured to be fastened to and unfastened from head wearable device not provided with any nose pads, thus creating an gaze tracking device;
the nose pad gaze tracking comprises a first part having a first part frame having a U-shaped portion including two arms and being adaptable and compatible with a nose bone of a user when in use, said first part frame housing at least one left eye sensor and one right eye sensor, said eye sensors being arranged on the arms to detect a plurality of pupil position images of the user when in use;
said module further comprises a second part having a second part frame and including a mechanical interface configured to connect the module to the head wearable device;
said module further comprising electronic components including at least a data processing unit, a memory, and a data interface, the electronic components being configured to connect the module to a computer device, and the electronic components being configured to send to said computer device eye movement information of the user wearing the head wearable device to which is fastened the nose pad gaze tracking module;
the module is configured to be used when mechanically fastened to the head wearable device, and the first part comprises two arms designed as nose pads configured to be customizable on different nose shapes when the module is fastened to the head wearable device; and
the mechanical interface is arranged on a top of second part frame and comprises specific electrical and electronic interfaces connectable to corresponding downward mechanical, electrical, and electronic interfaces arrangeable on one of a central portion of the head wearable device and a further extension of the central portion of the head wearable device, thus making the module configured to be bottom-up connectable to the head wearable device;
the method comprising:
providing said nose pad gaze tracking module;
providing the head wearable device; and
bottom-up fastening and connecting the nose pad gaze tracking module to the head wearable device at the central portion of the head wearable device to form a single unitary structure.

30. A gaze tracking device comprising:
a head wearable device; and
a nose pad gaze tracking module;
wherein the nose pad gaze tracking module is configured to be fastened to and unfastened from the head wearable device not having any nose pads, thus creating a gaze tracking device;
wherein said eye tracking module comprises a first part having a first part frame having a U-shaped portion including two arms, being adaptable and compatible with a nose bone of a user when in use, said first part frame housing at least one left eye sensor and one right eye sensor, said eye sensors being arranged on the arms to detect a plurality of pupil position images of the user when in use;
wherein said module further comprises a second part having a second part frame and including a mechanical interface configured to connect the module to the head wearable device, said gaze tracking module further comprising electronic components including at least a data processing unit, a memory, and a data interface, said electronic components configured to connect the module to a computer device, and to send to said computer device eye movement information of the user wearing the head wearable device to which is fastened the nose pad gaze tracking module;
wherein the module is configured to be used when mechanically fastened to the head wearable device, and the first part comprises two arms designed as nose pads configured to be customizable on different nose shapes when the module is fastened to the head wearable device; and
wherein the mechanical interface is arranged on a top of the second part frame and comprises electrical and electronic interfaces connectable to corresponding downward mechanical, electrical, and electronic interfaces arrangeable on one of a central portion of the head wearable device and a further extension of the central portion, thus making the module configured to be bottom-up connectable to the head wearable device.
